(19) United States
(12) Patent Application Publication
(10) Pub. No.: US 2023/0382499 A1
(43) Pub. Date: Nov. 30, 2023

(54) DIVE COMPUTER INTEGRATED NAVIGATION SYSTEM

(71) Applicants: Reima K. Holopainen, Zufikon (CH); Jari M.A. Tiira, Lenzberg (CH); Michal Ratajski, Moeriken (CH); Mathias Schnyder, Aarau (CH)

(72) Inventors: Reima K. Holopainen, Zufikon (CH); Jari M.A. Tiira, Lenzberg (CH); Michal Ratajski, Moeriken (CH); Mathias Schnyder, Aarau (CH)

(73) Assignee: Johnson Outdoors Inc., Racine, WI (US)

(21) Appl. No.: 17/825,161

(22) Filed: May 26, 2022

(51) Int. Cl. B63B 22/16; B63B 49/00; B63C 11/26; G01S 15/08; G01S 15/93; G08B 6/00; H04B 17/318; H04W 4/80

(52) U.S. Cl. CPC B63B 22/166; B63B 49/00; B63C 11/26; G01S 15/08; G01S 15/93; G08B 6/00; H04B 17/318; H04W 4/80; B63C 2011/021

(57) ABSTRACT

An underwater navigation system that includes a buoy configured to be anchored underwater or to be hung underwater from a boat. The buoy is configured to transmit a signal. A dive computer is configured to be carried by a diver, and also configured to receive the signal. The dive computer is further configured to display a distance and direction to the buoy based on the received signal.

### FIELD OF THE INVENTION

This invention generally relates to a navigational device, and more particularly, to an underwater navigational device.

### BACKGROUND OF THE INVENTION

For scuba divers, after spending a significant amount of time underwater, it can be very difficult for the diver to find his or her way back to the dive boat. Navigating underwater is challenging due limited visibility and the lack of clear visual reference. Traditionally, divers use a compass for direction and fin kick cycles for measuring the distance. Movement of the water, buoyancy-adjusting, and the aforementioned lack of visual references may cause the diver to deviate from a direct path and distance measurement so as to be very inaccurate. Furthermore, when several dive boats are within a close range, it can be difficult to find the boat from which the diver embarked.

Some inertial navigation systems improve the traditional track navigation by automatizing the compass direction and tilt measurements. However, with longer dive times, the drift causes increasing location error. High deviation from slow movement sensors (acceleration) can be improved by using flow sensors, but as water constantly flows in variable speed and direction, this solution only works when re-calibrated frequently.

Underwater navigation systems using triangulation receive a signal from multiple transmitters, which can be fixed, or which may use a GPS-based location on the surface. Such systems can accurately determine a current location and the travelled path can be stored. The system requires a number of transmitters, constant underwater communication between the transmitters and the receiver, and a good deal of processing power. As such, these systems tend to consume a lot of energy. In the end, the system cost and complexity make it generally unsuitable for recreational diving. Also, in triangulation-type systems, the receiver must be placed in a non-shadowed location, for example, on the diver's back, and from there the signal must be relayed somehow to the diver's wrist unit or heads up display. U.S. Pat. No. 9,225,435, and U.S. Patent Pub. No. 2009/0213697 disclose related underwater navigation systems, and the entire teachings and disclosures of this patent and patent publication are incorporated herein by reference.

Moreover, some other devices have been developed for underwater communication, or for determining range and bearing of objects under water. More specifically, the following U.S. patents disclose devices for possible use in underwater navigation: U.S. Pat. No. 4,563,758 issued to C. J. Paternostro; U.S. Pat. No. 4,604,733 issued to B. F. Brown, et al.; U.S. Pat. No. 5,185,605 issued to J. W. Roberts, Jr., et al.; and U.S. Pat. No. 5,331,602 issued to C. B. McLaren, the entire teachings and disclosures of which are incorporated herein by reference thereto.

Embodiments of the present invention provide an improved means for determining the distance and direction from a diver to a dive boat. These and other advantages of the invention, as well as additional inventive features, will be apparent from the description of the invention provided herein.

### BRIEF SUMMARY OF THE INVENTION

In one aspect, embodiments of the invention provide an underwater navigation system that includes a buoy configured to be anchored underwater or to be hung underwater from a boat. The buoy is configured to transmit a signal. A dive computer is configured to be carried by a diver, and also configured to receive the signal. The dive computer is further configured to display a distance and direction to the buoy based on the received signal.

In a particular embodiment, the signal is an ultrasonic signal. The ultrasonic signal may include a unique address to identify the buoy transmitting the signal. Furthermore, the ultrasonic signal may include two or more bits with a time delay between successive bits.

In certain embodiments, the buoy includes a sonar transmitter, and an antenna element. In other embodiments, the buoy further includes a buoy microcontroller, a buoy reference clock, and a buoy Bluetooth communications module. The buoy may further include a power source, an LED light, and a water contact. In a particular embodiment, the dive computer includes a sonar receiver, and a receiver antenna element. The dive computer may further include a dive computer microcontroller, a dive computer reference clock, and a dive computer Bluetooth communications module. In a further embodiment, the dive computer also has a user interface, a display, and an alarm. The alarm may be configured to provide haptic feedback.

In some embodiments, the dive computer includes one or more sensors. Those one or more sensors may include a magnetic field sensor, and a pressure sensor. Furthermore, the one or more sensors may include a tilt sensor, and a water contact. In a particular embodiment, the dive computer includes a microcontroller and an electric compass, and the microcontroller is configured to use data from the electric compass to determine a direction from the dive computer to the buoy.

In a further embodiment, the dive computer includes a microcontroller and a tilt sensor, and the microcontroller is configured to use data from the tilt sensor to compensate for a tilt angle between the buoy and the dive computer. In more particular embodiments, the buoy has a top end and a bottom end, and the buoy includes an anchor point at both the top and bottom ends, the anchor points providing a means for attachment to the buoy. Additionally, the buoy may include an LED light configured to flash in one or more different patterns, where each pattern specifies a different condition of the buoy. Further, the buoy may be configured to repeatedly transmit the signal at periodic intervals.

Embodiments of the dive computer have a microcontroller configured to compare the strength and direction of a just-received first signal with the strength and direction of a previously-received second signal.

In particular embodiments of the invention, the buoy has a first microcontroller and a first reference clock, and the dive computer has a second microcontroller and a second reference clock, and the first and second microcontrollers are configured to synchronize the first reference clock with the second reference clock. In some embodiments, at least one of the first and second reference clocks is an owen clock.

Furthermore, the first and second microcontrollers may be configured to synchronize the first and second reference clocks by sending a plurality of ultrasonic signals from the buoy to the dive computer. In a more particular embodiment, the first and second microcontrollers are configured to synchronize the first and second reference clocks by repeating an ultrasonic signal multiple times, and averaging between the detected times of the repeated ultrasonic signals.

In certain embodiments, the minimum number of ultrasonic signals needed to synchronize the first and second reference clocks is determined by the precision to be achieved by the dive computer. Alternatively, the first and second microcontrollers may be configured to synchronize the first and second reference clocks by sending a plurality radio waves from the buoy to the dive computer using the Bluetooth communications protocol.

In another embodiment, the dive computer has a first antenna oriented in a first direction, and a second antenna oriented in a second direction different from the first direction, wherein dive computer is configured to determine the direction to the buoy based on the relative strengths of the signals received by the first and second antennas. Further, the dive computer may include a microcontroller and a receiver antenna element, where the microcontroller configured to store an antenna beam pattern of the receiver antenna element, and further configured to determine a direction and tilt angle between the buoy and dive computer based on the stored antenna beam pattern and a strength of a signal received from the buoy.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a plan view of a buoy used in an underwater navigation system, according to an embodiment of the invention;

FIG. 2 is a schematic block diagram showing the elements of the buoy, according to an embodiment of the invention;

FIG. 3 is a perspective view of the dive computer used in an underwater navigation system, according to an embodiment of the invention;

FIG. 4 is a schematic block diagram showing the elements of the dive computer, according to an embodiment of the invention;

FIG. 5A is a schematic representation of a first exemplary ultrasonic packet with a 5-bit address, according to an embodiment of the invention;

FIG. 5B is a schematic representation of a second exemplary ultrasonic packet with a 5-bit address, according to an embodiment of the invention;

FIG. 6 is a schematic block diagram illustrating the synchronizing or pairing of the sonar drive on the buoy with the sonar receiver on the dive computer, and how this can be used to calculate the distance in the water, in accordance with an embodiment of the invention;

FIG. 7 is a schematic block diagram illustrating how ultrasonic packets are received by a dive computer that has an electric compass, in accordance with an embodiment of the invention;

FIG. 8 is a schematic block diagram showing how the dive computer antenna receives the signal transmitted from the buoy, in accordance with an embodiment of the invention;

FIG. 9 is another schematic block diagram illustrating how ultrasonic packets are received by a dive computer that has a tilt sensor, in accordance with an embodiment of the invention; and

FIG. 10 is a graphical illustration of an exemplary polar plot of an antenna beam pattern for the antenna element of the dive computer, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

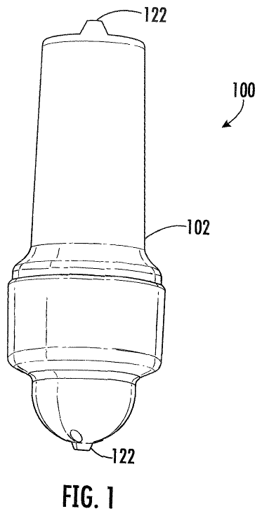

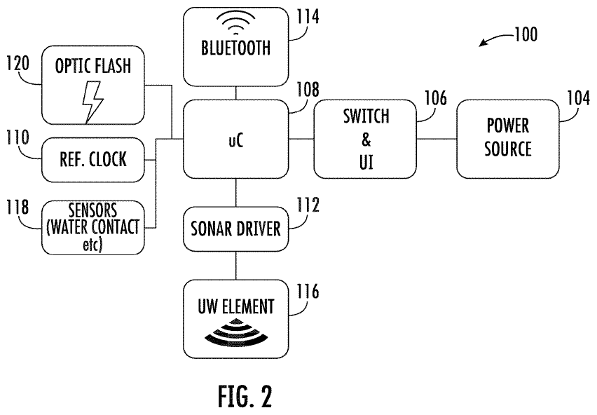

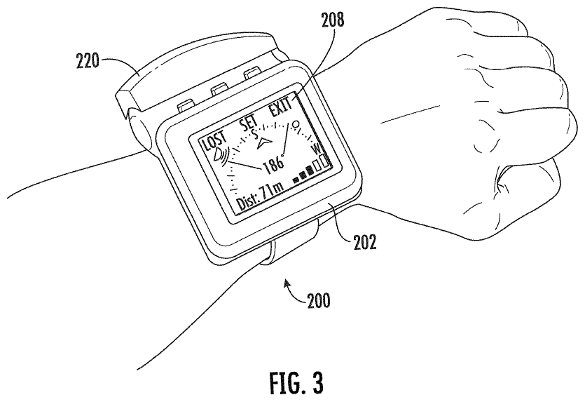

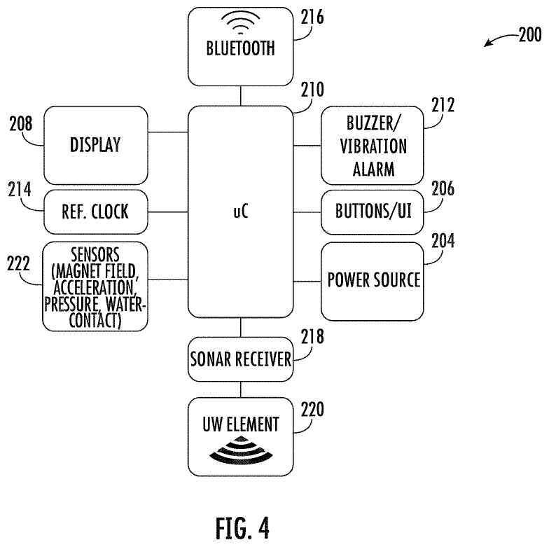

In a particular embodiment of the invention, the underwater navigation system includes two units: a buoy 100 and a dive computer 200 with integrated receiver. FIG. 1 is a plan view of the buoy 100, and FIG. 2 is a schematic block diagram showing the elements of the buoy 100. FIG. 3 is a perspective view of the dive computer 200, and FIG. 4 is a schematic block diagram showing the elements of the dive computer 200. The buoy 100 marks the location where the diver wants to navigate. In particular embodiments, the buoy 100 has a main body or housing 102 which is water-tight. The embodiment of the buoy 100 shown also includes a power source 104 (disposable or rechargeable), an on/off switch 106, a microcontroller 108, a clock source 110, an ultrasonic transmitter 112, a Bluetooth communications module 114, an ultrasonic antenna 116, an optional LED flash 120, and an optional water contact 118.

In some embodiments, the water contact 118 is configured to detect the presence of the water. In case of the buoy 100, the water contact 118 would know when it is under water (e.g., close Bluetooth communication does not work underwater), or, when taken out of the water, the water contact 118 could automatically either turn off, transition to a power saving mode, or even dim the flashlight, which could be otherwise very bright.

In certain embodiments of the buoy 100, the ultrasonic antenna 116 is an omnidirectional ultrasonic antenna, where the beam pattern is optimized so that antenna gain is the same on all sides and in all directions (i.e., for 360 degrees) around the antenna 116. The main signal may be directed downwards from the antenna 116. The buoy 100 can be hung from the side of the boat, anchored from a floating object, or anchored to a lakebed or riverbed. In specific embodiments, the buoy 100 has at least two anchoring points 122 (one at each longitudinal end of the buoy 100) so that the buoy 100 can be anchored either with the antenna 116 pointing down or pointing up.

In particular embodiments, the buoy 100 transmits signals as ultrasonic packets. Typically, each ultrasonic packet includes at least a unique address for identification of the buoy 100, as any one dive site could have multiple buoys 100. The unique address allows the diver to select the desired buoy 100 from among the multiple buoys 100 that may be located at a particular dive site.

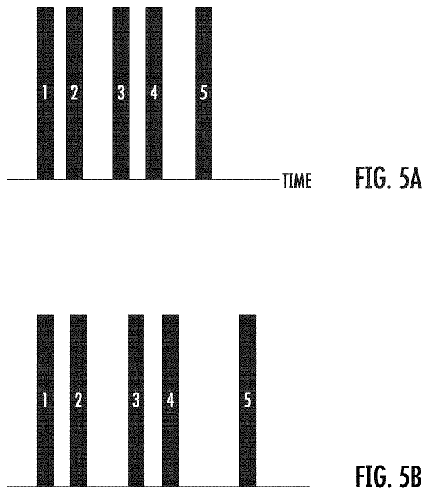

Each ultrasonic packet includes a series of bits with some specified time period or time delay between successive bits. In some embodiments, the time delay between packet address bits, as well as the value of the packet address bits, can be changed depending on the dive site. FIGS. 5A and 5B show schematic representations of two exemplary packets each with a 5-bit address. As can be seen, the two packets have the same coding, but the packet of FIG. 5B has a longer delay between bits than the delay in FIG. 5A. One of ordinary skill in the art would recognize that the buoy could be configured to transmit ultrasonic packets with fewer or greater than five bits.

Due to reflections and multiple signal paths traveling through the water, ultrasonic packets with a greater time delay between packet address bits are easier to detect in certain environments, for example, when there is a flat rock bottom that reflects ultrasonic waves well. In embodiments of the invention, the ultrasonic packet form and coding can be set by the dive computer 200 using the Bluetooth communications protocol.

The packet of FIG. 5A can be more suitable, for example, for a deep-water dive site, while the packet of FIG. 5B can be more suitable for shallow-water dive sites. Other dive site characteristics where one type of signal pattern, such as in FIG. 5A, may work better than the other shown in FIG. 5B include, but are not limited to, near a reef wall, a drop off, a sloping bottom, a kelp forest, etc. In a particular embodiment of the invention, the ultrasonic packets are repeated with preset time delays between successive bits, and those time delays are defined by the system clock 110. The time delay may be set so that, in the range of the buoy 100 (or environmental reflections), the current ultrasonic packet and the next ultrasonic packet after the current ultrasonic packet do not collide or interfere with one another.

In a particular embodiment, the buoy 100 has an electrical system that includes a precise clock 110. In such embodiments, the clock 110 can be a temperature-compensated type to increase the accuracy as the water temperature is normally much lower than the air temperature. In more particular embodiments, it could also be more precise owen clock 110 where the temperature of the clock is kept constant and independent of the environment. An owen clock 110 is kept at a stable temperature, as opposed to a clock where the user tries to compensate for a changing temperature. Normally, the selected stable temperature for the owen clock 110 is selected to be above the operating temperature, as it is generally easier to heat the clock 110 than to cool it down.

The buoy 100 can have a display or haptic feedback, however these can be eliminated by using a wireless communication protocol, such as Bluetooth, which operates in air when the buoy 100 is not submerged. Bluetooth communication can therefore replace all dynamic buttons which could be susceptible to water leakage. In its simplest form, the buoy 100 has only the on/off switch 106. When there is only a switch 106 to power the buoy 100, the Bluetooth mode is active for certain time period, which provides a window during which the buoy 100 can be programmed. After a predetermined time period, the Bluetooth mode is disabled and the buoy 100 works in underwater mode by sending the aforementioned ultrasonic packets for underwater navigation. The Bluetooth mode can also be disabled using a water sensing contact.

The buoy 100 may also include an optical navigation aid for close distance finding. This can be done by having multiple colors on the buoy housing 102. These colors are typically selected so that they have a high contrast to water and sunlight. For example, using a housing color combination of black and yellow provides some advantages. Black forms a high contrast in high-intensity sunny areas, while and yellow is well visible on cloudy days or at evenings/mornings.

For navigating at night or low light conditions, the buoy housing 102 or some part of the buoy housing 102 can be made from a self-luminescent material, which glows for some time after it has been exposed to light. Also, the buoy housing 102 may include a flashing or constant LED 120. In a specific embodiment, multiple LEDs 120 are placed around the housing 102 so that the light is visible from any direction. Alternatively, the housing 102 could have one LED 120 and a plurality of reflectors to direct light from the LED 120 for 360 degrees disposed around the entire housing 102. The LED 120 can also be used as a diagnostic tool allowing the user to determine whether the buoy 100 is working properly, i.e., constant interval flash, or to indicate battery life, for example short flashes to indicate low battery power, or not flashing at all to indicate that there is some kind of error with respect to the buoy 100, or with respect to the self-diagnostic routine of the buoy 100 initiated during start up. Thus, the LED light 120 may be configured to indicate a condition of the buoy 100 by flashing in one or more different pre-defined patterns, where each pattern specifies a different condition of the buoy 100.

In an alternative embodiment, the buoy housing 102 includes a combination of the aforementioned features where the self-luminescent material is exposed to pulses of light from the LED 120, and thereafter glows continually at a lower intensity than that of the pulses of light.

With respect to the dive computer 200 with integrated receiver, in certain embodiments, the dive computer 200 is carried by the diver and the integrated navigation receiver shows the direction and distance to the buoy 100. Integration of the navigation receiver into the dive computer 200 enhances the system's capabilities in several ways, and allows the diver to navigate underwater without the need to carry two different instruments.

The dive computer housing 202 is watertight and houses several elements. Inside of the housing 202 resides a power source 204, a user interface 206, a display screen 208, a microcontroller 210, electronic memory, an alarm with haptic feedback 212, for example a vibration alarm, a precision clock 214, a Bluetooth communications module 216, ultrasonic receiver 218, and ultrasonic antenna element 220. The dive computer 200 also include one or more sensors 222 which may include, but are not limited to, a pressure sensor, directional sensors such as an electric compass, one or more tilt sensors or acceleration sensors, and a water contact.

In a particular embodiment, the dive computer 200 is configured to use the microcontroller 210 and Bluetooth communications module 216 to configure the buoy 100. With this configuration for example, the ultrasonic packet address can be selected, the ultrasonic packet interval, or time delay, can be set, the flashing LED 120 can be enabled or dimmed, and the battery status or remaining operating time of the buoy 100 can be seen.

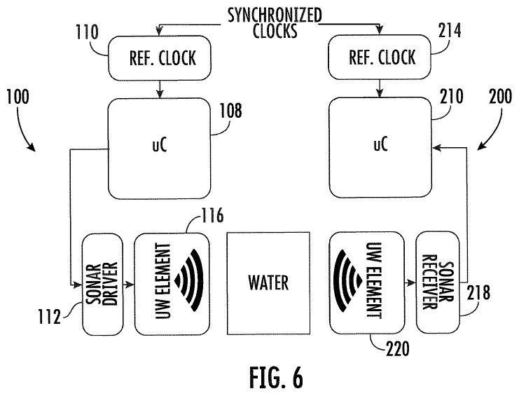

In certain embodiments, the dive computer 200 is synchronized or paired with the buoy 100 before the dive or at the start of the dive. FIG. 6 is a schematic block diagram illustrating the synchronizing or pairing of the sonar drive 112 on the buoy 100 with the sonar receiver 218 on the dive computer 200, in accordance with an embodiment of the invention. If the pairing is done before the dive, this can be completed via Bluetooth or by setting the ultrasonic receiver antenna 220 of the dive computer 200 in close proximity to the antenna 116 of the buoy 100. If the pairing is done via ultrasonic signals, multiple ultrasonic packets and “averaging” is used to achieve a precise synchronization between the reference clock 110 of the buoy 100 and the reference clock 214 of the dive computer 200. Averaging is used because the detection of the ultrasonic pulses happens with a relatively low frequency, and, as a result, there is typically some inaccuracy. In order to define a certain fixed signal level from which we can determine the correct time, the signal is repeated multiple times and averaged between the detected times in order to eliminate disturbances like noise, etc. This provides for a more precise synchronization between the transmitted signal and the received signal.

The minimum number of received ultrasonic packets needed, to accurately show the location of the buoy 100, is determined by the precision which must be achieved by the dive computer 200. Also, with ultrasonic pairing, a minimum signal level is typically required for valid packets.

If the diver is already in the water (i.e., Bluetooth doesn't work) and the diver wants to pair his or her dive computer 200 with the buoy 100, the minimum signal level of the ultrasonic packets requires the dive computer 200 to be physically close to the buoy 100. In a particular embodiment, the pairing is valid for a specified time period, also known as the synchronization time period, when the difference between the transmitter clock and the receiver clock is small enough to allow for accurate distance measurement. After the synchronization time period has elapsed, the buoy 100 and the dive computer 200 revert to their normal operating mode.

The pairing can be a specific mode for both the buoy 100 and the dive computer 200, or for the dive computer 200 only. Once the synchronization time period has elapsed, the dive computer 200 goes into a “timeout” mode. If that happens, the pairing must be redone between the buoy 100 and the dive computer 200 to synchronize the reference clocks 110, 214 of the two devices. If the dive computer 200 is submerged without a valid pairing, the dive computer 200 can be programmed to emit an alarm alerting the diver so that pairing can be done at the beginning of the dive. In the event of a long dive, even if the dive computer 200 does not enter the timeout mode during the dive, the dive computer 200 will continue to operate as normal. However, if the dive is very long, the timeout may occur right after surfacing. However, after surfacing, the distance calculation is not as importance because the diver should be able to see the boat or the buoy 100.

For example, one scenario provides that the synchronization between buoy 100 and dive computer 200 is defined to be valid for three hours, while the dive is just started about 2.5 hours into the three-hour synchronization period, and the expected dive time is one hour. The synchronization time period would end during the dive, thus resulting in the dive computer 200 entering a timeout mode. The dive computer 200 would continue to show the diver the distance and direction to the buoy 100. However, the timeout mode alerts the diver as to how much time has passed since the last synchronization of the reference clocks 110, 214. As this time between synchronizations increases, the inaccuracy of the dive computer's distance calculation may also increase.

When the dive computer 200 and buoy 100 are synchronized, the dive computer 200 is configured to calculate the distance between the two devices. The distance is based on the time that the ultrasonic packet was sent, the time the ultrasonic packet was received, and the speed of sound in the water. The dive computer 200 can use the parameters acquired by its one or more sensors 222, for example temperature or salinity, to accurately determine the speed of sound in the water.

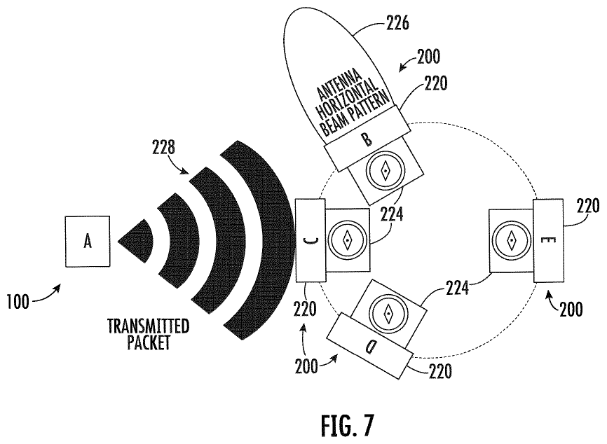

The direction of the buoy 100 is determined by the received packet signal strength. As illustrated in FIG. 7 and described below, comparing two different ultrasonic packet signals, the stronger packet signal is received when the antenna 220 of the dive computer 200 is directly facing the buoy 100, or has a smaller degree angular deflection away from the buoy 100. As the received packet signal strength is highest when the dive computer 200 is directly forward from the buoy, this is where the highest degree of accuracy is achieved. Furthermore, when a diver wants to navigate towards the buoy 100, the dive computer 200 is normally held by the diver so that the front of the dive computer 200 is pointing forwards.

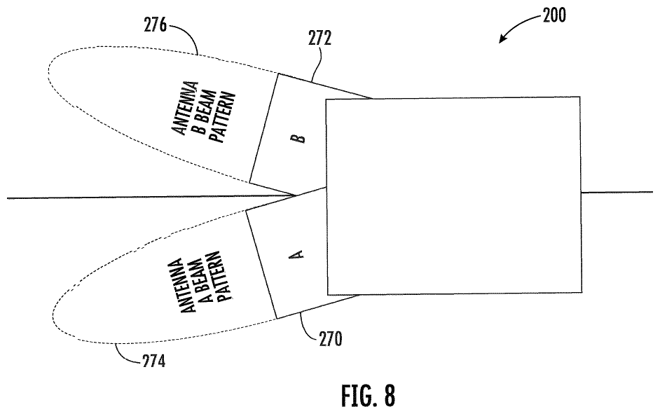

In cases where two different angled antennas and receivers are used, the signal strength from both can be compared. The buoy 100 is obviously more in direction of the stronger signal. This characteristic is illustrated in FIG. 8, which is a schematic block diagram showing how the dive computer 200 receives the signal transmitted from the buoy 100. In the embodiment of FIG. 8, the dive computer 200 has two separate antennas: a first antenna 270 oriented in a first direction and a second antenna 272 which is oriented in a second direction different from the first direction. First antenna 270 has a first antenna beam pattern 274 and the second antenna 272 has a second antenna beam pattern 276. The direction to the buoy 100 can be determined by the relative strengths of the signals received by the first and second antennas 270, 272.

FIG. 7 is a schematic block diagram illustrating how ultrasonic packets are received by the dive computer 200 which includes an integrated electric compass 224, in accordance with an embodiment of the invention. As shown in FIG. 7, the antenna 220 has a horizontal beam pattern 226. Due to the shape of the horizontal beam pattern 226, the packet signal 228 transmitted by the buoy 100 is best received by the dive computer antenna 220 when in Position C (i.e., the dive computer facing West if the top of the page is North). Packet signal reception is weaker in Positions B and D, and no signal at all is received in Position E. By including the integrated electric compass 224 in the dive computer 200, the device 200 is able to compare previously-received packet signals to current packet signals, allowing the dive computer 200 to perform instant direction correction.

When the packet signal is received, the dive computer 200, which has the integrated electric compass 224, stores the compass reading at that time. The compass reading can be compared to previous compass readings, and the zone where the buoy 100 is located can be narrowed. Also, if the received ultrasonic packet shows that the buoy 100 is further away, and the dive computer 200 can determine a maximum traveling speed of the diver in the water, the valid direction to the buoy 100 can be held in the electric compass 224 longer. At close distances, the compass direction is valid for shorter time period.

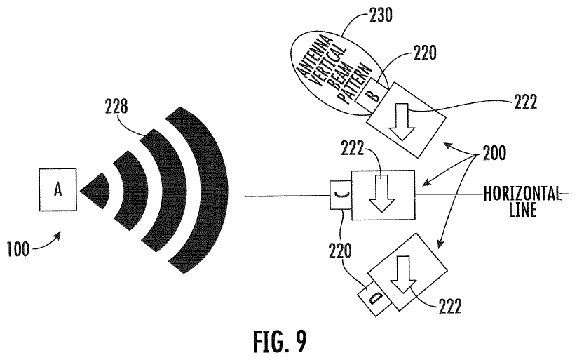

FIG. 9 is another schematic block diagram illustrating how ultrasonic packets are received by the dive computer 200 which includes the tilt sensor 222, in accordance with an embodiment of the invention. As shown in FIG. 9, the antenna 220 has a vertical beam pattern 230. Due to the shape of the vertical beam pattern 230, the packet signal 228 transmitted by the buoy 100 is best received by the dive computer antenna 220 when in Position C. However, using data from the tilt sensor 222, the microcontroller 210 of the dive computer 200 is configured to determine the variation from horizontal of the packet signal 228, and to compensate for any tilt angle between transmission of the packet signal 228 and the antenna 220 of the dive computer 200. Thus, the dive computer 200 is able to compensate for the difference in the depths or tilt angle between the buoy 100 and the dive computer 200, where the tilt angle is determined by the magnitude of the difference in the depths.

In a further embodiment, a pressure sensor 222 provides the current depth, and if the buoy 100 is set near the surface, the angular tilt direction of the buoy 100 can be estimated, or, if anchored, the horizontal direction to the anchoring point of the buoy 100 can be estimated.

To save power on the dive computer 200, the navigation receiver 218 can be set to a low-power sleep mode. When the diver wants to navigate towards the buoy 100, this can be done, for example, by activating the navigation by pressing a button on the user interface 206. In a particular embodiment, when the navigation is started, the ultrasonic receiver 218 is set in high-gain mode. When an ultrasonic packet is received by the dive computer 200, a distance between the buoy 100 and the dive computer 200 can be calculated.

As the ultrasonic packets are sent with a known interval, or time delay, between successive bits, and when one ultrasonic packet is received by the dive computer 200, the receiver 218 can be switched off to further save power until the expected time window for the next ultrasonic packet. When in close proximity to the buoy 100, the dive computer 200 can set the ultrasonic receiver 218 in low-gain mode automatically so that the direction accuracy is optimal.

In a typical embodiment, the dive computer 200 is worn on the diver's wrist. The somewhat-fixed position on the diver's wrist during use of the navigational system, which helps to stabilize the ultrasonic receiver 218 and helps to keep the dive computer 200 horizontal or level. Furthermore, the three-dimensional acceleration sensors 222 (also referred to as “tilt sensors”) of the dive computer 200 are able to detect if the receiver antenna 220 is tilted, and this can be compensated for when the three-dimensional pattern of the receiver antenna 220 is known.

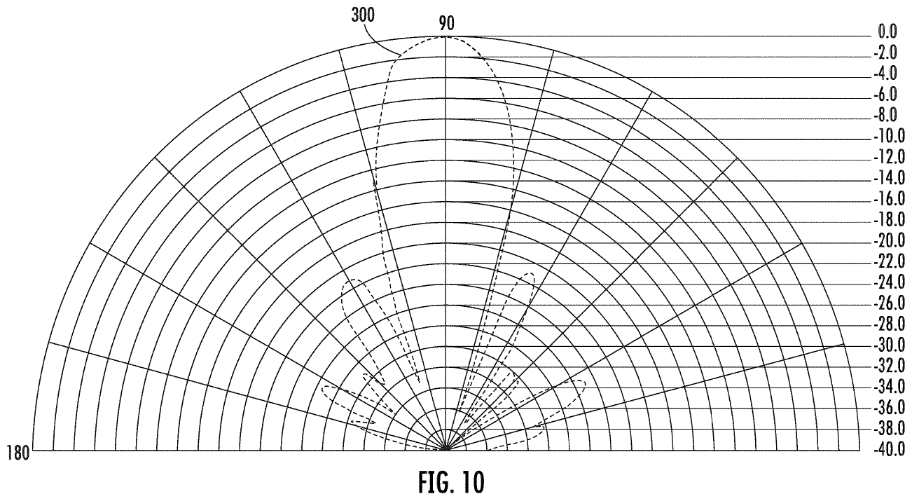

FIG. 10 is a graphical illustration of an exemplary polar plot of an antenna beam pattern 300 for the antenna element 220 of the dive computer 200. Because the antenna element 220 has a beam pattern (i.e., gain) in each rotational axis, the direction and tilt angle to the buoy 100 can be determined based on the antenna beam pattern 300 and corresponding gain in each of the three-dimensions. As can be seen from FIG. 10, the antenna beam pattern 300 has, in the rotational axis shown, a much higher gain towards 90 degrees (top) and smaller side slope gains towards zero degrees and 180 degrees.

When the distance measuring between the buoy 100 and the dive computer 200 is based on a common reference clock 110, 214, the navigation system can be built by using uni-directional communication. The power consumption of the dive computer 200 can be minimized and the size can be optimized. The receiver 218 can be coupled more efficiently to the receiver antenna 220. Respectively, when the buoy 100 only needs to transmit, it can be optimized for this purpose.

Magnetic sensors 222 in the dive computer 200 may be used to determine the direction of the received packet and the strength of these can be stored in the electronic memory of the microcontroller 210. The strength and direction of the next received ultrasonic packet can be compared to that of the previous packet. The stronger of these two signals is likely to be from the dive computer 200 in which the antenna 220 is oriented more directly towards the buoy 100. The dive computer 200 can therefore calculate the angle from where the signal is coming. Furthermore, other sensors 222 of the dive computer 200 are used to increase its directional accuracy. As explained above, using data from the tilt sensor 222, the microcontroller 210 can compensate for the ultrasonic packets which are received when the antenna 220 is not horizontal with respect to the packet signal 228 transmitted by the buoy 100.

In a situation where a diver gets lost and cannot visually determine the way back to the dive boat, the diver can initiate a 360-degree sweep with the dive computer 200, which is a specific mode programmed into the dive computer 200. This mode guides the diver through specific steps needed to acquire the direction to the buoy 100. When the ultrasonic receiver 218 detects an ultrasonic packet transmitted by the buoy 100, the dive computer 200 shows, on the display, the scanned directions and the tilt deviation. While the best results may be achieved when the dive computer 200 is kept in the horizontal position, the dive computer 200 is also configured to compensate for a tilt angle between the buoy 100 and dive computer 200. The dive computer 200 stores the packet strength and direction during the sweep. When the scan is complete, if there were multiple received packets, the dive computer 200 identifies the strongest packet signal which likely from the direction directly ahead of the antenna 220 at the time the signal was received, thus providing a direction to the buoy 100. Reflections in case of multipath travel of the signal can be eliminated as they are typically weaker in strength as direct path.

Embodiments of the invention, described above, provide improved navigational features as compared to conventional underwater navigation systems. Unlike some conventional systems, the dive computer 200 does not require the diver to sweep and hold the ultrasonic receiver 218 in a constant horizontal, or level, position in order to get a proper directional heading. The requirement to maintain the receiving unit in a level position can be difficult underwater as the diver is in constant motion, even when just floating, without a fixed point of reference.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An underwater navigation system comprising:
a buoy configured to be anchored underwater or to be hung underwater from a boat, the buoy configured to transmit a signal; and
a dive computer configured to be carried by a diver, the dive computer configured to receive the signal, and further configured to display a distance and direction to the buoy based on the received signal.

2. The underwater navigation system of claim 1, wherein the signal is an ultrasonic signal.

3. The underwater navigation system of claim 2, wherein the ultrasonic signal includes a unique address to identify the buoy transmitting the signal.

4. The underwater navigation system of claim 2, wherein the ultrasonic signal comprises two or more bits with a time delay between successive bits.

5. The underwater navigation system of claim 1, wherein the buoy includes a sonar transmitter, and an antenna element.

6. The underwater navigation system of claim 5, wherein the buoy further includes a buoy microcontroller, a buoy reference clock, and a buoy Bluetooth communications module.

7. The underwater navigation system of claim 5, wherein the buoy further includes a power source, an LED light, and a water contact.

8. The underwater navigation system of claim 1, wherein the dive computer includes a sonar receiver, and a receiver antenna element.

9. The underwater navigation system of claim 8, wherein the dive computer further includes a dive computer microcontroller, a dive computer reference clock, and a dive computer Bluetooth communications module.

10. The underwater navigation system of claim 8, wherein the dive computer further includes a user interface, a display, and an alarm.

11. The underwater navigation system of claim 10, wherein the alarm provides haptic feedback.

12. The underwater navigation system of claim 8, wherein the dive computer further includes one or more sensors.

13. The underwater navigation system of claim 12, wherein the one or more sensors includes a magnetic field sensor, and a pressure sensor.

14. The underwater navigation system of claim 12, wherein the one or more sensors includes a tilt sensor, and a water contact.

15. The underwater navigation system of claim 1, wherein the dive computer includes a microcontroller and an electric compass, and wherein the microcontroller is configured to use data from the electric compass to determine a direction from the dive computer to the buoy.

16. The underwater navigation system of claim 1, wherein the dive computer includes a microcontroller and a tilt sensor, and wherein the microcontroller is configured to use data from the tilt sensor to compensate for a tilt angle between the buoy and the dive computer.

17. The underwater navigation system of claim 1, wherein the buoy has a top end and a bottom end, and wherein the buoy includes an anchor point at both the top and bottom ends, the anchor points providing a means for attachment to the buoy.

18. The underwater navigation system of claim 1, wherein the buoy has an LED light configured to flash in one or more different patterns, where each pattern specifies a different condition of the buoy.

19. The underwater navigation system of claim 1, wherein the buoy is configured to repeatedly transmit the signal at periodic intervals.

20. The underwater navigation system of claim 19, wherein the dive computer has a microcontroller configured to compare the strength and direction of a just-received first signal with the strength and direction of a previously-received second signal.

21. The underwater navigation system of claim 1, wherein the buoy has a first microcontroller and a first reference clock, and the dive computer has a second microcontroller and a second reference clock, and wherein the first and second microcontrollers are configured to synchronize the first reference clock with the second reference clock.

22. The underwater navigation system of claim 21, wherein the first and second microcontrollers are configured to synchronize the first and second reference clocks by sending a plurality of ultrasonic signals from the buoy to the dive computer.

23. The underwater navigation system of claim 22, wherein the minimum number of ultrasonic signals needed to synchronize the first and second reference clocks is determined by the precision to be achieved by the dive computer.

24. The underwater navigation system of claim 22, wherein the first and second microcontrollers are configured to synchronize the first and second reference clocks either by sending a plurality of ultrasonic signals from the buoy to the dive computer, or by using the Bluetooth communications protocol to send signals from the buoy to the dive computer.

25. The underwater navigation system of claim 22, wherein the first and second microcontrollers are configured to synchronize the first and second reference clocks by repeating an ultrasonic signal multiple times, and averaging between the detected times of the repeated ultrasonic signals.

26. The underwater navigation system of claim 21, wherein one of the first and second reference clocks is an owen clock.

27. The underwater navigation system of claim 1, wherein the dive computer has a first antenna oriented in a first direction, and a second antenna oriented in a second direction different from the first direction, wherein dive computer is configured to determine the direction to the buoy based on the relative strengths of the signals received by the first and second antennas.

28. The underwater navigation system of claim 1, wherein the dive computer includes a microcontroller and a receiver antenna element, the microcontroller configured to store an antenna beam pattern of the receiver antenna element, and further configured to determine a direction and tilt angle between the buoy and dive computer based on the stored antenna beam pattern and a strength of a signal received from the buoy.
